(19) United States
(12) Patent Application Publication
(10) Pub. No.: US 2010/0145585 A1
(43) Pub. Date: Jun. 10, 2010

(54) METHOD FOR CONTROLLING THE SLIP OF A DIRECT DRIVE CLUTCH OF A TORQUE CONVERTER

(75) Inventors: Beatrice Gesnot, Paris (FR); Thomas Turpin, Orsay (FR); Catherine Vauthier, Montigny Le Bretonneux (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne Billancourt (FR)

(21) Appl. No.: 12/523,660

(22) PCT Filed: Jan. 7, 2008
(86) PCT No.: PCT/FR2008/050016

§ 371 Date: Feb. 2, 2010

(30) Foreign Application Priority Data
Jan. 19, 2007 (FR) 0700384

(51) Int. Cl. G06F 19/00; F16H 61/14

(52) U.S. Cl. 701/68

(57) ABSTRACT

A method for controlling slip of a direct-drive clutch of a torque converter during a gear change in an automated transmission, that includes sending, as a set point, values of a cyclic opening ratio to an electro-valve for adjusting hydraulic pressure of the direct-drive clutch, wherein the initial value is determined from parameters resulting from a mapping. The value of the initial cyclic opening ratio sent as a set point is the value of the nominal initial cyclic opening ratio determined by a mapping, that is corrected by a predetermined correction coefficient memorized at the end of a previous similar gear change, from a comparison between a value of a slip representative of the slip values measured during the previous change and that of a theoretical reference slip corresponding to a nominal engine speed and turbine speed.

The invention relates to a method of controlling the slip of the direct-drive clutch of a torque converter during a gear shift of an automatic transmission.

Such a method of controlling the clutch slip is known and is of the kind whereby there are transmitted, by way of set point, to an electrically-operated valve that regulates the hydraulic pressure of the direct-drive clutch, open duty cycle values, the initial value of the set point being determined on the basis of parameters from a map.

In general, a set point transmitted at a given moment during the gear shift is defined as a function of the instantaneous values of the engine speed and of the turbine speed which are measured a few fractions of a second before the set point is transmitted, these values themselves being the result of the slipping of the direct-drive clutch and therefore of a set point previously transmitted to the regulating electrically-operated valve. Hence, whatever the quality of the method of controlling the slip, particularly by ensuring the correctness of the open duty cycle with respect to the desired amount of slip, this control method has difficulty in preventing undesired jolts or overspeedings of the turbine at the start of the gear shift, it not being possible for the initial value of the set point to depend on instantaneous values of engine speed and turbine speed measured a few fractions of a second beforehand. All this goes hand in hand with the fact that there may be disparity between vehicles, drifting of the direct-drive clutch over time and drifting, over time, of the disparities in the parameters used to determine the initial value of the open duty cycle.

The present invention aims to remedy the abovementioned drawbacks.

According to the invention, in the method of the aforementioned type, the transmitted initial open duty cycle value transmitted as set point is the normal initial open duty cycle value determined by a map corrected by a corrective coefficient which is determined and stored at the end of a similar previous gear shift on the basis of the comparison between the value of a representative slip that represents the measured slip values measured during this previous gear shift and the value of a reference theoretical slip corresponding to nominal engine and transmission speeds.

Thus, the method makes it possible to improve the quality of the control over the slip at the start of the gear shift by transmitting an initial set point that is dependent on earlier engine and turbine speeds.

Other particulars and advantages of the present invention will become apparent through the detailed description of one embodiment which is given by way of nonlimiting example and illustrated by the attached drawings, in which:

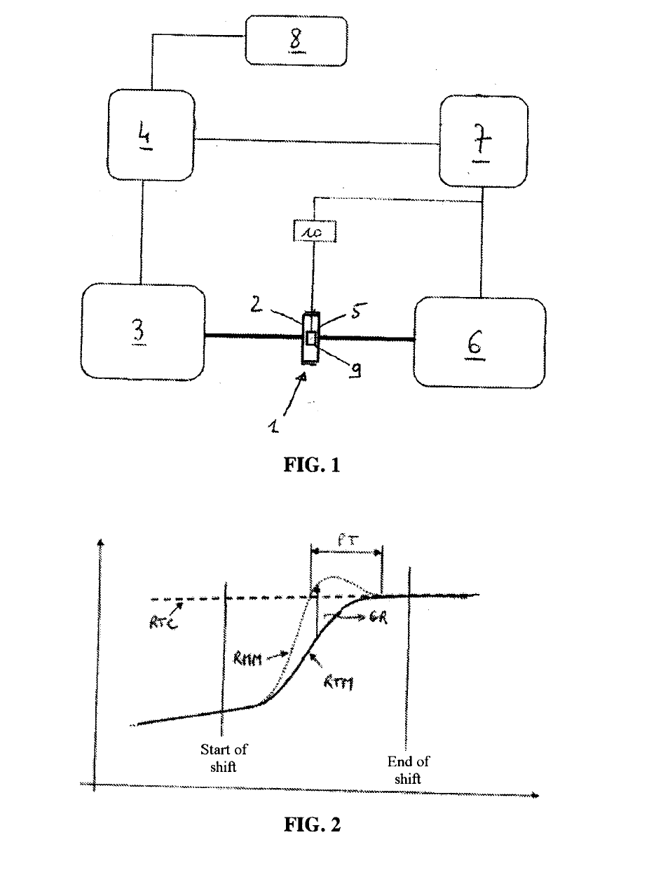

FIG. 1 is a diagram illustrating the various parts of a vehicle that can interact with a torque converter, and

FIG. 2 is a schematic depiction of the change in engine and turbine speed during a downshift.

In the conventional way, a torque converter 1 comprises, on the one hand, a pump 2 which is connected to engine 3 operated through an engine control unit 4 and, on the other hand, a turbine 5 which is connected to a transmission 6 operated by a transmission control unit 7, the two control units 4, 7 being connected to one another and to an operating member 8 under the control of a user (the throttle pedal). In addition, the torque converter also comprises a direct-drive clutch 9 used to secure the turbine 5 to the pump 2 or allow relative slipping of these two components 2, 5, according to the circumstances, by modifying the oil pressure in the clutch chamber. The pressure is regulated by a proportional regulating electrically-operated valve 10, which is made to be either fully open or fully closed, with a variable open duty cycle the value of which is transmitted by way of set point by the transmission control unit 7.

In the conventional way, at the start of a gear shift, the transmission control unit 7 calculates the parameters needed to manage the gear shift and determines whether it is necessary to slip the direct-drive clutch 9, and if it is, the transmission control unit 7 calculates the value of the initial open duty cycle RCOIE to be transmitted to the regulating electrically-operated valve 10 by way of initial set point.

According to the present invention, the transmitted initial open duty cycle value RCOIE is the normal initial open duty cycle value RCOIN corrected by a stored corrective coefficient CCM in the EEPROM random access memory of the transmission control unit 7. If the gear shift in progress is the first of this type (since the vehicle was started), the stored corrective coefficient CCM is equal to a predetermined initial constant KI. In this embodiment, the transmitted initial open duty cycle value RCOIE is equal to the product of the normal initial open duty cycle value RCOIN times the stored corrective coefficient CCM (RCOIE=RCOIN×CCM), the initial constant KI then being equal to 1.

The EEPROM memory therefore contains as many stored corrective coefficient CCM values as needed (as a function of the type of gear shift, of the oil temperature, of the engine torque).

The value of the normal initial open duty cycle RCOIN is determined in the conventional way as a function of the parameters previously calculated by the transmission control unit 7 for managing the gear shift, for example using a map. These parameters are, for example, the type of gear shift in progress, the engine torque, the vehicle speed and the oil temperature of the direct-drive clutch 9.

Subsequent control of the slipping of the direct-drive clutch is conventional.

The stored corrective coefficient CCM has been determined at the end of the previous gear shift of the same type on the basis of the comparison between, on the one hand, the value of a slip GR which is representative of the calculated slip GC values calculated during the previous gear shift and, on the other hand, the value of a reference theoretical slip GT corresponding to nominal engine and transmission speeds. Here, the comparison between the value of the representative slip GR and the value of the reference theoretical slip GT is performed by determining the difference between these two values (GR-GT).

In the present embodiment, the value of the representative slip GR is the maximum value of the calculated slips GC calculated in a time period PT extending over the previous gear shift of the same type. This time period PT is the period during which the measured engine speed RMM was higher, during the previous gear shift of the same type, than the calculated turbine speed RTC calculated on the final speed ratio. This calculated turbine speed RTC is equal to the product of the vehicle speed times the final speed ratio. The value of a slip GC is equal to the difference between the value of the measured engine speed RMM and the value of the measured turbine speed RTM (GC=RMM-RTM).

The value of the theoretical slip GT is obtained, in this embodiment, on the basis of a map as a function of the type of gear shift in progress.

In this example, the stored corrective coefficient CCM has been determined from a standardized corrective coefficient CCN. This standardized corrective coefficient CCN has been obtained from a map as a function of the type of gear shift in progress, of the oil temperature of the direct-drive clutch, of the engine torque and of the result of the comparison between the value of the representative slip GR and the value of the reference theoretical slip GT (here, the result of the comparison is GR-GT). More specifically, the stored corrective coefficient CCM has been determined on the basis of the standardized corrective coefficient CCN via an ideal corrective coefficient CCI which is determined on the basis of the standardized corrective coefficient CCN and of the previous stored corrective coefficient CCMA (the one that was stored in the EEPROM random access memory at the start of the previous gear shift). Here, the ideal corrective coefficient CCI is equal to the product of the standardized corrective coefficient CCN times the previous stored corrective coefficient CCMA (CCI=CCN×CCMA).

In this embodiment, the stored corrective coefficient CCM has been determined by weighting the ideal corrective coefficient CCI by the previous stored corrective coefficient CCMA in order to obtain filtering. In this particular instance, the weighting is performed using the sum of the ideal corrective coefficient CPI assigned a first weighting coefficient CC1 and of the previous stored corrective coefficient CCMA assigned a second weighting coefficient CP2 (CCM=CCI×CP1+CCMA×CP2). In this instance, the first weighting coefficient CP1 is comprised between 0 and 1, the second weighting coefficient CP2 being its ones complement (CP2=1−CP1). This stored corrective coefficient CCM is stored in the EEPROM random access memory in place of the previous stored corrective coefficient CCMA.

Thus, at the start of a first gear shift, the random access memory contains a stored corrective coefficient CCMA which is used to determine the transmitted initial open duty cycle RCOIE. At the end of this first gear shift, the random access memory still contains the same stored corrective coefficient CCMA on the basis of which the ideal corrective coefficient CCI is determined, then the new stored corrective coefficient CCM is calculated and stored.

Furthermore, in this embodiment, at the end of a gear shift, the stored corrective coefficient CCM is determined on the basis of the behavior of the direct-drive clutch 9 during this gear shift only if certain conditions dependent on this gear shift are met. In this particular instance, there are three conditions that have to be met: the operating point needs to have been stabilized throughout the gear shift (the position of the throttle pedal needs to be stable), the oil temperature of the direct-drive clutch needs to remain within a predefined temperature range throughout the gear shift, and throughout the gear shift, the turbine has not to overspeed. In this instance, the absence of turbine overspeeding is achieved when the difference between the calculated turbine speed RTC calculated on the final speed ratio and the measured turbine speed RTM (RTC-RTM) remains below a predetermined threshold.

The weighting coefficients CP1, CP2, the temperature range to be observed when calculating the stored corrective coefficient CCM and the threshold that defines turbine overspeeding are calibrated values.

The present invention is not restricted to the embodiment described hereinabove. Thus, it might be possible for the ideal corrective coefficient CCI not to be weighted, the stored corrective coefficient CCM then being equal to the ideal corrective coefficient CCI. Likewise, the weighting could be more complex. It might also be possible for the EEPROM memory to be arranged in such a way that a single stored corrective coefficient CCM is valid, for one type of gear shift, for an entire oil temperature range associated with an engine torque range.

1-14. (canceled)

15. A method of controlling slip of a direct-drive clutch of a torque converter during a gear shift of an automatic transmission, comprising:
transmitting, by way of set point, to an electrically-operated valve that regulates hydraulic pressure of the direct-drive clutch, open duty cycle values of which the transmitted initial value transmitted as set point is a normal initial open duty cycle value determined by a map corrected by a corrective coefficient determined and stored at an end of a similar previous gear shift based on a comparison between a value of a representative slip that represents the measured slip values measured during the previous gear shift and a value of a reference theoretical slip corresponding to a nominal engine speed and a nominal turbine speed,
wherein the value of the representative slip is the maximum value of the measured slips measured in a time period extending over the previous gear shift.

16. The method as claimed in claim 15, wherein the transmitted initial open duty cycle value is equal to the product of the normal initial open duty cycle value times the stored corrective coefficient.

17. The method as claimed in claim 15, wherein the comparison between the value of the representative slip and the value of a theoretical slip is performed by determining the difference between these two values.

18. The method as claimed in claim 15, wherein the time period is the period during which the measured engine speed was higher than the calculated turbine speed calculated on the final speed ratio.

19. The method as claimed in claim 15, wherein the stored corrective coefficient is determined from a standardized corrective coefficient obtained from a map as a function of a type of gear shift in progress, of a oil temperature of the direct-drive clutch, of engine torque, and of a result of the comparison between the value of the representative slip and the value of a theoretical slip.

20. The method as claimed in claim 19, wherein the stored corrective coefficient has been determined from an ideal corrective coefficient determined based on a standardized corrective coefficient and of a previous stored corrective coefficient.

21. The method as claimed in claim 20, wherein the ideal corrective coefficient is equal to the product of the standardized corrective coefficient times the previous stored corrective coefficient.

22. The method as claimed in claim 20, wherein the stored corrective coefficient is equal to the ideal corrective coefficient.

23. The method as claimed in claim 20, wherein the stored corrective coefficient is equal to the ideal corrective coefficient weighted by the previously stored corrective coefficient.

24. The method as claimed in claim 23, wherein the weighting is performed using the sum of the ideal corrective coefficient assigned a first weighting coefficient between 0 and 1, and of the previous stored corrective coefficient assigned a second weighting coefficient that is the ones complement of the first weighting coefficient.

25. The method as claimed in claim 15, wherein the transmitted corrective coefficient is calculated at the end of the gear shift only if learning conditions dependent on this gear shift are met.

26. The method as claimed in claim 25, wherein one of the learning conditions is that the operating point must have stabilized.

27. The method as claimed in claim 25, wherein one of the learning conditions is that the oil temperature of the direct-drive clutch must be kept within a temperature range.

28. The method as claimed in claim 25, wherein one of the learning conditions is that the difference between the calculated turbine speed calculated on the final speed ratio and the measured turbine speed must be kept at a value below a predetermined threshold.
